(19) United States
(12) Patent Application Publication
(10) Pub. No.: US 2008/0102817 A1
(43) Pub. Date: May 1, 2008

(54) METHOD AND SYSTEM FOR SHARING CELLULAR PHONES

(75) Inventors: Daryoosh Shenassa, Libertyville, IL (US); Changxue C. Ma, Barrington, IL (US); Deborah A. Matteo, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/553,679

(22) Filed: Oct. 27, 2006

(51) Int. Cl. H04Q 7/20

(52) U.S. Cl. 455/425

(57) ABSTRACT

A method (40) and system (10 or 200) for sharing a cellular phone includes sending (41) a request to use a second cellular phone (12) as a server from a first cellular phone (11), exchanging (43) audio streams between the cellulars phone, receiving (44) a dialing signal at the first cellular phone from the second cellular phone and forming (45) a call connection between the first cellular phone and a third party (13) via the second cellular phone. The step of sending the request can include sending an SMS message, sending a phone number, or sending a push-to-share request for nearby cellular phones having stronger signal strength. The push-to-share request can be a Bluetooth search of nearby cellular phones having stronger signal strength for their cellular network connection. The method can also include automatically (42) sending the push-to-share request upon detection of a signal strength below a predetermined threshold.

### FIELD

This invention relates generally to portable communications, and more particularly to a method and system for sharing a portable wireless communication unit.

### BACKGROUND

Cellular phones are pervasive communication devices that are also considered personal to most individuals. Cellular phone owners use their cell phones in both private and public situations. Cellular phones are now used in homes, cars, buses, trains, train stations, airports, and streets to name a few locations. Cell phones store personal information such as telephone numbers, email addresses, appointments, family pictures, emails, short messages, personal notes, among other personal items.

There are many reasons why a user “UA” carrying his or her cellular phone “CA” might want to borrow the cell phone “CB” of another user “UB”. In special situations, for a short period of time, a cellular phone owner might be willing to let other cellular phone users make use of the services that his or her cellular phone offers (e.g., voice call, SMS). While it is quite common for people in many countries outside the United States to borrow cellular phones from their owners to make an important short phone call, the lenders worry about possible abuse of their phone. The borrower may run away with the phone, see the personal information in the phone, erase some important information in the phone by accident, alter user preferences, or cause other problems for the owner. Thus, the cellular phone lenders are typically unwilling to physically hand their cell phones to another person while they have no objection to share their cell phone in a secure way. Although there are known ways to operably couple a first communication unit to one or more neighboring communication units to share some functions, such systems fail to enable sharing a cellular phone in a secure manner where physical possession of the lender's cellular phone is not sacrificed. Even a cellular phone using Bluethooth wireless communication that provides a three-in-one phone usage model that allows a mobile phone to be used as a cellular phone in the standard manner, as a cordless phone connecting to a voice access point (cordless phone base station), and as an intercom or “walkie-talkie” for direct phone-to-phone communications with another device in proximity” fails to provide a secure means of sharing cellular phones among different users.

### SUMMARY

Embodiments in accordance with the present invention can enable a cellular phone owner to share their cellular phone services with another cellular phone owner without physically handing or surrendering the owner's phone.

In a first embodiment of the present invention, a method of sharing a cellular phone can include the steps of sending a request to use a second cellular phone as a server from a first cellular phone, exchanging audio streams between the first cellular phone and the second cellular phone, receiving a dialing signal at the first cellular phone from the second cellular phone and forming a call connection between the first cellular phone and a third party via the second cellular phone. The method can further include the step of using Bluetooth to exchange audio using Synchronous Connection-Oriented (SCO) packets. The method can also use a serial port connection to exchange phone numbers and Short Messaging Service (SMS) text between the first cellular phone and the second cellular phone. The step of sending the request can include sending an SMS message, sending a third party phone number, or sending a push-to-share request for nearby cellular phones having stronger signal strength. The push-to-share request can be a Bluetooth search of nearby cellular phones having stronger signal strength for their cellular network connection. The method can also include automatically sending the push-to-share request upon detection of a signal strength below a predetermined threshold at the first cellular phone. The method can further include the step of receiving an acknowledgement from the second cellular phone enabling the first cellular phone to use the second cellular phone as the server or access point to make a call to a third party.

In a second embodiment of the present invention, a system of sharing a cellular phone can include a transceiver and a processor coupled to the transceiver. The processor can be programmed to send a request to use a second cellular phone as a server from a first cellular phone having the transceiver, exchange audio streams between the first cellular phone and the second cellular phone, receive a dialing signal at the first cellular phone from the second cellular phone and form a call connection between the first cellular phone and a third party via the second cellular phone. The processor can be further programmed to use Bluetooth to exchange audio using Synchronous Connection-Oriented (SCO) packets and further programmed to use a serial port connection to exchange phone numbers and Short Messaging Service (SMS) text between the first cellular phone and the second cellular phone. The processor can send the request by sending an SMS message, by sending a third party phone number, by sending an email, by sending an attachment with an email, or by sending a URL link. The processor can also send the request by using a push-to-share request for nearby cellular phones having stronger signal strength for their cellular network connection. The processor can also be programmed to automatically send the push-to-share request upon detection of a signal strength below a predetermined threshold at the first cellular phone. The processor can also be programmed to receive an acknowledgement from the second cellular phone enabling the first cellular phone to use the second cellular phone as the server or access point to make a call to a third party.

In a third embodiment of the present invention, a portable wireless communication unit having a system of sharing can include a transceiver and a processor coupled to the transceiver. The processor can be programmed to send a request to use a second cellular phone as a server from the portable wireless communication unit using a push-to-share request, exchange audio streams between the portable wireless communication unit and the second cellular phone, receive a dialing signal at the portable wireless communication unit from the second cellular phone and form a call connection between the portable wireless communication unit and a third party via the second cellular phone. The processor can be further programmed to use Bluetooth to exchange audio using Synchronous Connection-Oriented (SCO) packets and further programmed to use a serial port connection to exchange phone numbers and Short Messaging Service (SMS) text between the first cellular phone and the second cellular phone. The processor can also send the request by sending an SMS message, by sending a third party phone number, by sending an email, by sending an attachment with an email, or by sending a URL link. The processor can send the request by automatically sending the push-to-share request for nearby cellular phones having stronger signal strength for their cellular network connection upon detection of a signal strength at the portable wireless communication unit below a predetermined threshold. The processor can further be programmed to receive an acknowledgement from the second cellular phone enabling the portable wireless communication unit to use the second cellular phone as the server or access point to make a call to a third party.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a system of sharing a cellular phone in accordance with an embodiment of the present invention.

FIG. 2 is a flow chart of a method of sharing a cellular phone in accordance with an embodiment of the present invention.

FIG. 3 is an illustration of a Bluetooth profile that can be used in accordance with an embodiment of the present invention.

FIG. 4 is an illustration of a Bluetooth profile that includes an audio gateway using SCO packets similar to a headset profile and a serial port for phone numbers and SMS text in accordance with an embodiment of the present invention.

FIG. 5 is another illustration of a system of sharing a cellular phone in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enable a cellular phone user to share or use another cellular phone to place a call without having to physically surrender the owner's cellular phone.

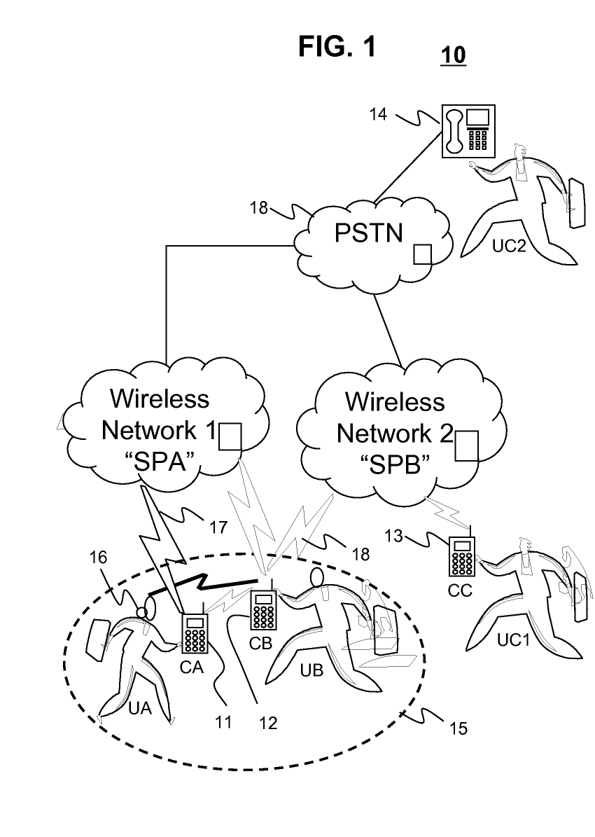

Referring to a communication system 10 of FIG. 1, a cellular phone 11 or CA of a user (UA) is used as a client and can be within a short communication range 15 of another cellular phone 12 or CB belong to another user (UB). The cellular phone 11 can send dialing information to the cellular phone 12. The cellular phone 12 can receive an audio stream from the cellular phone 11 and the cellular phone 12 can also send an audio stream back to the cellular phone 11. The cellular phone 12 can act as a server and the cellular phone 11 can act as a client. Thus, cellular phone 12 can receive a dialing signal and makes a call connection via wireless link 18 to a third party. Cell phone 12 streams audio to cell phone 11 and receives audio stream from cell phone 11 or alternatively the cellular phone 12 can stream audio to a wireless headset adaptor 16 for the cellular phone 11. In one embodiment, if cellular phone 11 is attempting to make a call to a third party such as user “UC1” having cellular phone 13 or to another third party such as user “UC2” having landline phone 14 and the cellular connection or link 17 to a first wireless network is weak, the cellular phone 11 (or its corresponding headset adaptor 16) can seek other cellular phones (12) within an area 15 that can serve as a server to make a call connection to such third party (UC1 or UC2). The other cellular phone 12 can be on the same wireless network as cellular phone 11 or can alternatively be on another wireless network. The third party can also be on the landline 14 and coupled to a wireless network via a public switched telephone network (PSTN) 18. As will be further discussed below, the cellular phone 11 can selectively search and select other phones or can in other embodiments automatically search for other cellular phones to serve as a server when its cellular link 17 to a wireless network is below a predetermined threshold.

The cellular phone 12 or the lender's phone, while in borrowed use or serving as a server can be temporarily unavailable to the lender, but the lender can retain control or the option to use his or her phone by canceling the borrowed usage of their phone. Of course, cancellation of borrowed usage can possibly be avoided in a multi-line phone. Another feature can include a visual or audible notification that a borrower completed their call or message. In this way, the lender will know that their phone is again available for normal operation. In one embodiment, the phone can provide a presentation that the owner of borrower's phone or phone 11 “thanks you” for lending the phone as notification that the borrower has completed their call or message. The borrower's name can be extracted from caller ID or from a phonebook for example.

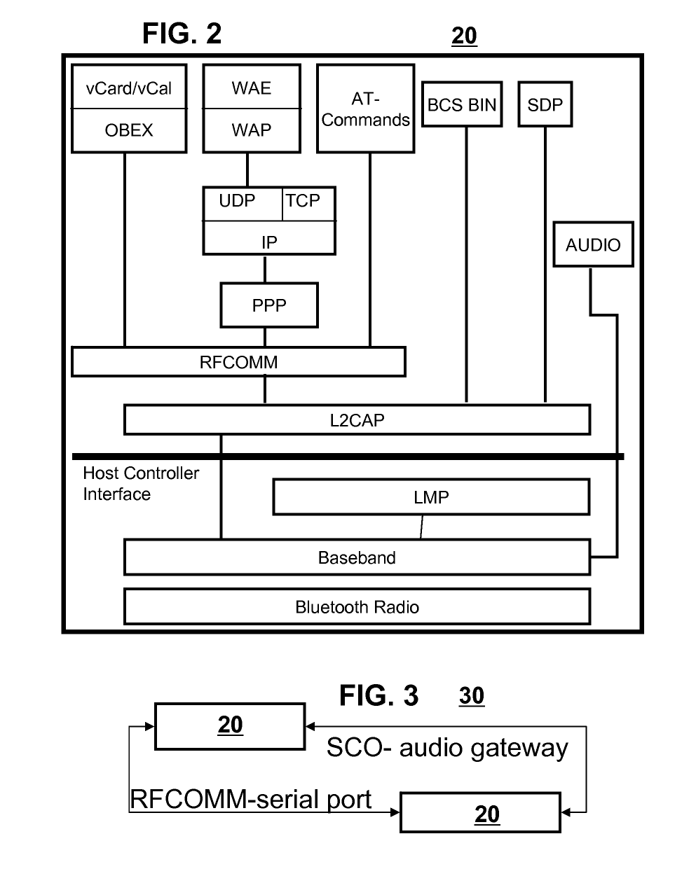

In this regard, Bluetooth technology can be used in various implementations. As shown in FIG. 2, a Bluetooth profile 20 for this application can be used in a system 30 as shown in FIG. 3 that includes an audio gateway that uses Synchronous Connection-Oriented (SCO) packets (similar to “Headset Profile”) and a serial port (Serial Port Profile) for phone numbers and SMS text.

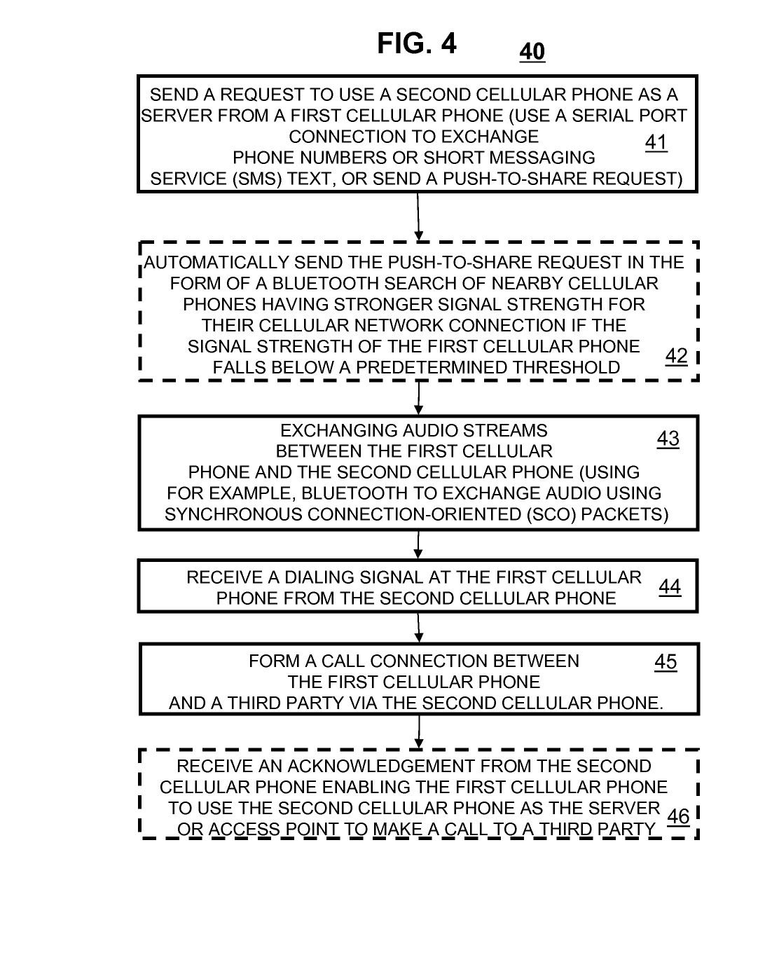

Referring to FIG. 4, a flow chart illustrating a method 40 of sharing a cellular phone can include the step 41 of sending a request to use a second cellular phone as a server from a first cellular phone, exchanging audio streams between the first cellular phone and the second cellular phone at step 43, receiving a dialing signal at the first cellular phone from the second cellular phone at step 44 and forming a call connection at step 45 between the first cellular phone and a third party via the second cellular phone. The method 40 can further include the step of using Bluetooth to exchange audio using Synchronous Connection-Oriented (SCO) packets. The method can also use a serial port connection to exchange phone numbers and Short Messaging Service (SMS) text between the first cellular phone and the second cellular phone. The step of sending the request can include sending an SMS message, sending a third party phone number, or sending a push-to-share request for nearby cellular phones having stronger signal strength. The push-to-share request can be a Bluetooth search of nearby cellular phones having stronger signal strength for their cellular network connection. The method 40 can also include automatically sending the push-to-share request at step 42 upon detection of a signal strength below a predetermined threshold at the first cellular phone. The method 40 can further include the step of receiving at step 46 an acknowledgement from the second cellular phone enabling the first cellular phone to use the second cellular phone as the server or access point to make a call to a third party.

Below lists 5 example use cases that can utilize embodiments in accordance with the invention. The following shows the abbreviations used in these 5 use cases:

### UA—a user (User A), a man in the use cases

### UB—another user (User B), a woman in the use cases

### CA—cell phone A belonging to UA (User A)

### CB—cell phone B belonging to UB (User B)

### CY—cell phone belonging to UA (user A) operational in country Y

### SPA—service provider of UA (User A)

### SPB—service provider of UB (User B)

Use Case 1

UA owns a GSM phone (CA). His service provider is SPA

UB also owns a GSM phone (CB). Her service provider is SPB.

UA needs to make an important phone call, but his service provider (SPA) happens to not have good coverage in that area.

UB's service provider (SPB) has good coverage in that area. She would be willing to let UA use her cell phone (CB) if there existed a safe way (e.g., UA makes a phone call while UB is holding the cell phone in her hand).

Use Case 2

UA travels from one country “X” to another country “Y”.

UA has arrived in the airport in the country Y.

UA has a GSM phone (CA) whose International Mobile Equipment Identity (IMEI) starts with “01”, i.e. 01xxxxxxxxxxxxx.

The cellular network, operated by the governments of country Y, does not allow CA to operate in country Y. The network routinely rejects all cell phones whose IMEI start with “01” (e.g. cell phones manufactured in US).

UB's service provider (SPB) has a good coverage in that area. She would be willing to let UA use her cell phone (CB) if there existed a safe way (e.g. UA makes a phone call while UB is holding the cell phone in her hand).

Use Case 3

The user UA in use case 2 travels to country Y often, thus he decides to buy a 2nd cell phone (CY) to use while he is inside country Y.

UA also carries his original cell phone (CA) since he has configured it exactly the way he likes it.

UA has stored in his phone (CA) all telephone umbers and email addresses of all of his contacts, his canned short messages, important received short messages, his important appointments, etc.

UA can now use his CY in the same manner as in USE CASE 2 above (to connect to the network), but still have all the conveniences he is accustomed to when using his CA. This means it is transparent to UA that his CA does not work in country Y.

Use Case 4

The user UA in use case 2 travels to country Y (a non-English speaking country) once in a while for a short period of time.

A family member (UB) lends her cell phone (CY) to UA to use during his short visit (or UA rents a cell phone CY).

CY is configured in a non-English language (all menus, names in the phone book, etc. in a non-English language).

UA also carries his original cell phone (CA) since he has configured it exactly the way he likes it.

UA has used English language to store in his phone (CA) all contact names, telephone umbers, his canned short messages, important received short messages, his important appointments, etc.

UA can now use his CA or CY phone in the same manner as in USE CASE 2 above (to connect to the network), but all of his interaction with the phone is in English.

All the use cases are Multiple Access (MA) agnostic which means the borrowed cell phone may be any type of cellular phone using any protocol stack: TDMA (2G, 3G), CDMA, Iridium, or the like.

Several extended use cases can be implemented as well. For example, if UA wishes to share the services subscribed to by UB if UB is near and has better or cheaper service. Such a scenario can make sense in an environment where there are members of the same family or company that subscribe to different services or service providers that have different rate plans or service. In another extended example, UA can read the signal strength of CB (cell phone of UB) before deciding to ask UB to share. As example:

UA needs to share.

UA sees UB near him carrying a cell phone (CB) on the belt.

UA's cell phone (CA) reads the signal strength of UB's cell phone (CB) to its cellular service provider network.

UA asks UB to share only if CB has good signal strength.

This use case may require modification to UB's cell phone (CB) to allow inspection of mobile signal strength. This use case may also require extensions to the Bluetooth standards.

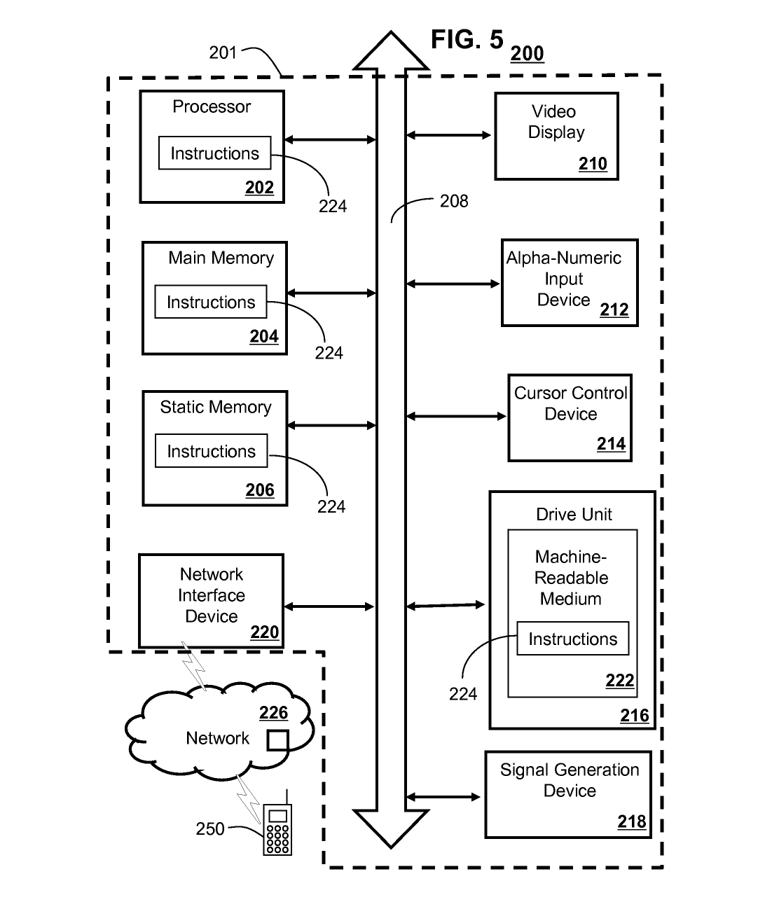

FIG. 5 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of sharing a cellular phone, comprising the steps of:
sending a request to use a second cellular phone as a server from a first cellular phone;
exchanging audio streams between the first cellular phone and the second cellular phone;
receiving a dialing signal at the first cellular phone from the second cellular phone; and
forming a call connection between the first cellular phone and a third party via the second cellular phone.

2. The method of claim 1, wherein the method further comprises the step of using Bluetooth to exchange audio using Synchronous Connection-Oriented (SCO) packets.

3. The method of claim 2, wherein the method further comprises the step of using a serial port connection to exchange phone numbers and Short Messaging Service (SMS) text between the first cellular phone and the second cellular phone.

4. The method of claim 1, wherein the step of sending the request comprises sending an SMS message.

5. The method of claim 1, wherein the step of sending the request comprises sending a third party phone number.

6. The method of claim 1, wherein the step of sending the request comprises a push-to-share request for nearby cellular phones having stronger signal strength.

7. The method of claim 6, wherein the step of sending the request comprises a Bluetooth search of nearby cellular phones having stronger signal strength for their cellular network connection.

8. The method of claim 6, wherein the method further comprises the step of automatically sending the push-to-share request upon detection of a signal strength below a predetermined threshold at the first cellular phone.

9. The method of claim 1, wherein the method further comprises the step of receiving an acknowledgement from the second cellular phone enabling the first cellular phone to use the second cellular phone as the server or access point to make a call to a third party.

10. A system of sharing a cellular phone, comprising:
a transceiver; and
a processor operationally coupled to the transceiver, wherein the processor is programmed to:
send a request to use a second cellular phone as a server from a first cellular phone having the transceiver;
exchange audio streams between the first cellular phone and the second cellular phone;
receive a dialing signal at the first cellular phone from the second cellular phone; and
form a call connection between the first cellular phone and a third party via the second cellular phone.

11. The system of claim 10, wherein the processor is further programmed to use Bluetooth to exchange audio using Synchronous Connection-Oriented (SCO) packets and further programmed to use a serial port connection to exchange phone numbers and Short Messaging Service (SMS) text between the first cellular phone and the second cellular phone.

12. The system of claim 10, wherein the processor sends the request by sending an SMS message, by sending a third party phone number, by sending an email, by sending an attachment with an email, or by sending a URL link.

13. The system of claim 10, wherein the processor sends the request by using a push-to-share request for nearby cellular phones having stronger signal strength for their cellular network connection.

14. The system of claim 13, wherein the processor is further programmed to automatically send the push-to-share request upon detection of a signal strength below a predetermined threshold at the first cellular phone.

15. The system of claim 10, wherein the processor is further programmed to receive an acknowledgement from the second cellular phone enabling the first cellular phone to use the second cellular phone as the server or access point to make a call to a third party and wherein the second cellular phone receives the request from the first phone and further relays information between the third party and the first cellular phone.

16. A portable wireless communication unit having a system of sharing, comprising:
a transceiver; and
a processor coupled to the transceiver, wherein the processor is programmed to:
send a request to use a second cellular phone as a server from the portable wireless communication unit using a push-to-share request;
exchange audio streams between the portable wireless communication unit and the second cellular phone;
receive a dialing signal at the portable wireless communication unit from the second cellular phone; and
form a call connection between the portable wireless communication unit and a third party via the second cellular phone.

17. The portable wireless communication unit of claim 16, wherein the processor is further programmed to use Bluetooth to exchange audio using Synchronous Connection-Oriented (SCO) packets and further programmed to use a serial port connection to exchange phone numbers and Short Messaging Service (SMS) text between the first cellular phone and the second cellular phone.

18. The portable wireless communication unit of claim 16, wherein the processor sends the request by sending an SMS message, by sending a third party phone number, by sending an email, by sending an attachment with an email, or by sending a URL link.

19. The portable wireless communication unit of claim 16, wherein the processor sends the request by automatically sending the push-to-share request for nearby cellular phones having stronger signal strength for their cellular network connection upon detection of a signal strength at the portable wireless communication unit below a predetermined threshold.

20. The portable wireless communication unit of claim 16, wherein the processor is further programmed to receive an acknowledgement from the second cellular phone enabling the portable wireless communication unit to use the second cellular phone as the server or access point to make a call to a third party.
